(19) United States
(12) Patent Application Publication
(10) Pub. No.: US 2012/0117032 A1
(43) Pub. Date: May 10, 2012

(54) INFORMATION PROCESSING DEVICE, ELECTRONIC APPARATUS, INFORMATION PROCESSING METHOD, AND PROGRAM

(75) Inventor: Tomonori Masumura, Kanagawa (JP)

(73) Assignee: SONY CORPORATION, Tokyo (JP)

(21) Appl. No.: 13/286,809

(22) Filed: Nov. 1, 2011

(30) Foreign Application Priority Data
Nov. 9, 2010 (JP) 2010-250625

(51) Int. Cl. G06F 17/30

(52) U.S. Cl. 707/674; 707/E17.007

(57) ABSTRACT

An information processing device including: a storage device in which a plurality of files are stored in a file group in which a plurality of files are associated with one another and in a file group format in which the association is regulated, and which is able to delete a stored file; and a control unit that is able to restore a file that is deleted from files that are stored in the storage device, wherein in a case when a file that is stored in the storage device is deleted, the control unit restores a deleted file and restores the restored file to a file structure according to a file group format by arranging a file that matches a file group format in a structure of a file group format based on a restored file.

### BACKGROUND

The present disclosure relates to an information processing device for restoring files that are recorded on a storage device such as a memory card or a hard disk drive (HDD), various types of recording media such as optical discs and magnetic disks, an electronic apparatus, an information processing method, and a program.

In a case when deletion, formatting error, access denial, or the like of a file of a storage medium occurs for any given reason, such as an operation mistake, within a storage device such as an HDD, there is software for restoring such a file.

Such file restoration software is able to restore a hard disk or a removable medium (external HDD, memory card, or the like) such that access becomes possible as before the deletion, formatting error, access denial, or the like of a file occurred.

That is, the file restoration software extracts a file from a mistakenly deleted medium, a mistakenly formatted medium, a medium to which access has been denied for any given reason, or the like, and is able to restore the file such that access becomes possible as before.

As such a type of file restoration technique, for example, a data processing device as disclosed in Japanese Unexamined Patent Application Publication No. 8-227372 is known.

In such a data processing device, it is possible to restore a file by recovering a FAT chain that is lost for any given reason.

Japanese Unexamined Patent Application Publication No. 2007-122339 is an example of related art.

### SUMMARY

The technique disclosed in Japanese Unexamined Patent Application Publication No. 8-227372 is an effective measure in a case when individual files are units which are reproduced from an application.

However, with the technique described above, in a case of an application when a plurality of files are to be saved in mutually associated form, even if one file is able to be restored, if a file on which the information of the file is to be recorded is not updated, it is difficult to reproduce the restored file.

For example, the AVCHD (Advanced Video Coded High Definition) format applies to such an application.

FIG. 1 is a diagram for describing the outline of an AVCHD file structure.

As illustrated in FIG. 1, the AVCHD format includes a moving image file main body 1 and a database file 2 that manages the moving image file main body 1, and a folder in which file names and files are saved is designated. The moving image file main body 1 is known as a Clip AV stream.

In the example of FIG. 1, a first moving image file 1-1 with the file name “00001.MTS” and a second moving image file 1-2 with the file name “00003.MTS” are present in the moving image file main body 1. Here, MTS is a file extension.

Information such as the file names or the screen sizes of moving image files is stored in the database file 2. The database file 2 is, in practice, divided into a plurality of files.

Here, in a camera as an electronic apparatus, it is supposed that a moving image file, for example, the first moving image file 1-1 as illustrated in FIG. 2, is mistakenly deleted.

Accompanying deletion, the content of the database file 2 is also rewritten, and the data (00001.MTS) of the deleted moving image file is erased.

In a case when restoring the erased file, with an existing restoration device as described above, as illustrated in FIG. 3, there is a possibility that the deleted moving image file itself is able to be restored.

However, it is difficult to restore the database file 2 to a state in which information of the restored moving image file is present.

It is desirable to provide an information processing device in which it is possible to restore, in a case when a file is stored in a file group in which a plurality of files are associated with one another and in a file group format in which the association is regulated, a restored file to a state in which the associated information of the restored file is present, an electronic apparatus, an information processing method, and a program.

According to a first embodiment of the disclosure, an information processing device including: a storage device in which a plurality of files are stored in a file group in which a plurality of files are associated with one another and in a file group format in which the association is regulated, and which is able to delete a stored file; and a control unit that is able to restore a file that is deleted from files that are stored in the storage device, wherein in a case when a file that is stored in the storage device is deleted, the control unit restores a deleted file and restores the restored file to a file structure according to a file group format by arranging a file that matches a file group format in a structure of a file group format based on a restored file.

According to a second embodiment of the disclosure, an electronic apparatus includes: an information processing device that restores a file that is deleted from files in which a plurality of files are stored in a predetermined format, wherein the information processing device includes a storage device in which a plurality of files are stored in a file group in which a plurality of files are associated with one another and in a file group format in which the association is regulated, and which is able to delete a stored file and a control unit that is able to restore a file that is deleted from files that are stored in the storage device, wherein in a case when a file that is stored in the storage device is deleted, the control unit restores a deleted file and restores the restored file to a file structure according to a file group format by arranging a file that matches a file group format in a structure of a file group format based on a restored file.

According to a third embodiment of the disclosure, information processing method including: storing a plurality of files in a file group in which a plurality of files are associated with one another and in a file group format in which the association information is regulated and restoring a file that is deleted from files that are stored in the storage device, wherein in the restoring, in a case when a file that is stored in the storage device is deleted, a deleted file is restored, and by arranging a file that matches a file group format in a structure of a file group format based on a restored file, the restored file is restored to a file structure according to a file group format.

According to a fourth embodiment of the disclosure, a program that causes a computer to execute information processing of: storing a plurality of files in a storage device in a file group in which a plurality of files are associated with one another and in a file group format in which the association information is regulated; and restoring a file that is deleted from files that are stored in the storage device, wherein in the restoration process, in a case when a file that is stored in the storage device is deleted, a deleted file is restored, and by arranging a file that matches a file group format in a structure of a file group format based on a restored file, the restored file is restored to a file structure according to a file group format.

According to embodiments of the disclosure, in a case when a file is stored in a file group in which a plurality of files are associated with one another and in a file group format in which the association is regulated, it is possible to restore the restored file to a state in which the associated information of the restored file is present.

### BRIEF DESCRIPTION OF THE DRAWINGS

FIG. 1 is a diagram for describing the outline of an AVCHD file structure;

FIG. 2 is a diagram that illustrates a state in which one moving image file is deleted;

FIG. 3 is a diagram that illustrates a state in which a deleted moving image file is restored by an existing file restoration device;

FIG. 4 is a diagram that illustrates an outline configuration of an information processing device that is applied to an electronic apparatus according to an embodiment of the disclosure;

FIG. 5 is a diagram for describing the gist of an AVCHD file structure according to the embodiment;

FIG. 6 is a diagram that schematically illustrates a state in which a database file is restored in the embodiment;

FIG. 7 is a diagram that illustrates the specific relationship between files of the AVCHD format;

FIG. 8 is a diagram that illustrates a file structure of the AVCHD format before file deletion;

FIG. 9 is a diagram that illustrates a file structure of the AVCHD format when the file (play item #0) is deleted;

FIG. 10 is a diagram that illustrates a file structure of the AVCHD format when a management file is generated after restoring a stream file;

FIG. 11 is a flowchart for describing the overall procedure of a file restoration process in an information processing device according to the embodiment;

FIG. 12 is a flowchart for describing a process of compiling AVCHD stream files into a list;

FIGS. 13A and 13B are perspective diagrams that illustrate a digital camera to which an information processing device of the embodiment is able to be applied;

FIG. 14 is a perspective diagram that illustrates a notebook personal computer to which an information processing device of the embodiment is able to be applied;

FIG. 15 is a perspective diagram that illustrates a video camera to which an information processing device of the embodiment is able to be applied; and

FIGS. 16A to 16G are perspective diagrams that illustrate a mobile terminal device, for example, a mobile phone, to which an information processing device of the embodiment is able to be applied.

### DETAILED DESCRIPTION OF EMBODIMENTS

Embodiments of the disclosure will be described below with reference to the drawings.

Here, description will be made in the following order.
1. Outline Configuration of Entirety of Information Processing Device
2. File Group Format
3. AVCHD Format (AVCHD File Structure)
4. Specific Example of Restoration Process by AVCHD Format
5. Overall Flow of Restoration Procedure
6. Configuration Example of Electronic Apparatus

### <1. Outline Configuration of Entirety of Information Processing Device>

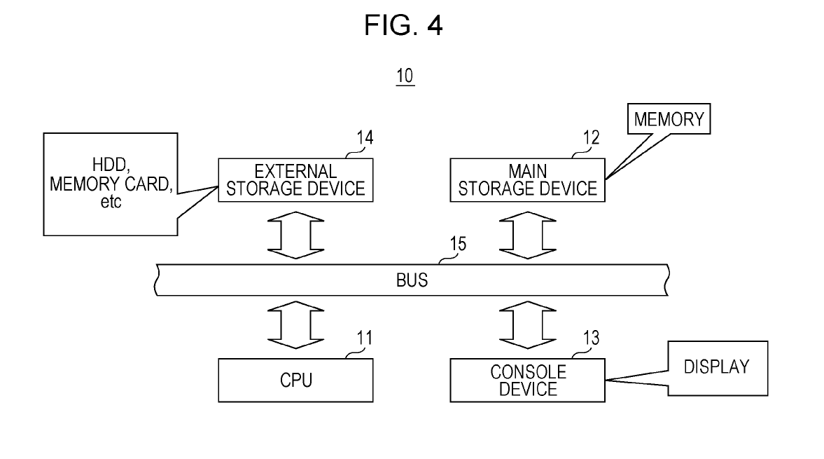

FIG. 4 is a diagram that illustrates an outline configuration of an information processing device that is applied to an electronic apparatus according to an embodiment of the disclosure.

An information processing device 10 includes a CPU 11 as a control unit, a main storage device 12, a console device 13, and an external storage device 14.

The CPU 11 is connected to each of the main storage device 12, the console device 13, and the external storage device 14 via a bus 15.

The information process device 10 is installed on an electronic apparatus such as a personal computer, a digital still camera, a digital video camera, a video apparatus, or a game apparatus.

The CPU 11 as a control unit performs control of the entirety of the information processing device 10.

The CPU 11 performs access control to the external storage device 14.

As will be described later, the CPU 11 has a function of restoring a file that is deleted from files that are stored on a storage device.

Further, the CPU 11 has a function of storing a plurality of files in a file group format in which a plurality of files are associated with one another and in a file group format in which the association is regulated in the external storage device 14.

The CPU 11 is able to restore a file that is deleted from files that are stored in a storage device in such a file group format.

In such a manner, storage of files and control of restoration by the CPU 11 in the external storage device 14 are performed. The control will be further described later.

The main storage device 12 includes a ROM for accommodating a program, a RAM that is a working memory, and the like, and is accessed by the CPU 11.

The console device 13 interfaces with a user (operator), and for example, the user is able to perform, through the console device 13, an instruction or the like for the deletion or restoration of a file that is stored on the external storage device 14.

The external storage device 14 is formed by an HDD that is fixed or interchangeable on a device, a portable memory device, or the like.

In the external storage device 14, a plurality of files are stored by the control unit of an electronic apparatus that is installed in a file group format in which a plurality of files are associated with one another and in a file group format in which the association is regulated.

Further, the external storage device 14 is able to delete stored files.

As a file group format by which files are stored in the external storage device 14, an AVCHD format that stores a high-definition moving image stream file that is shot by a camera that is an electronic apparatus in a storage device as digital data is exemplified.

### <2. File Group Format>

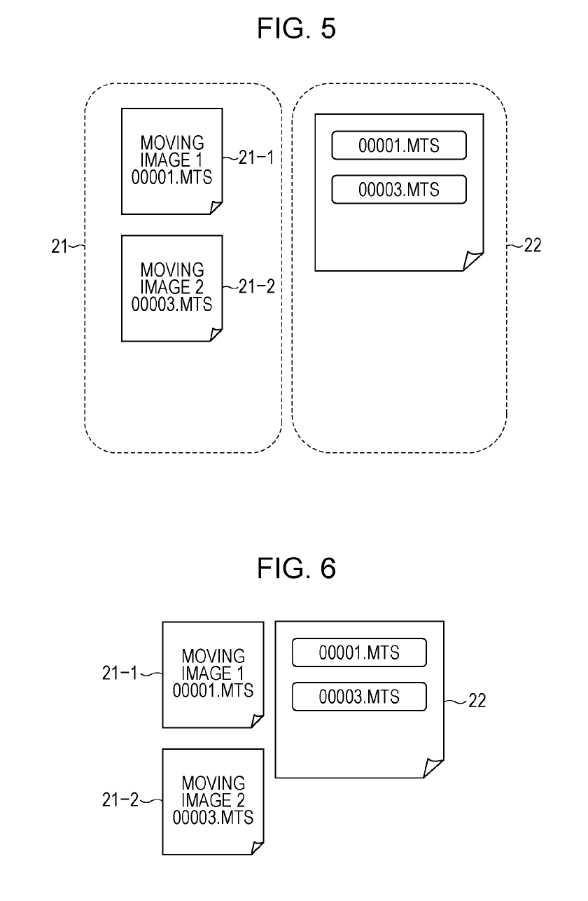

FIG. 5 is a diagram for describing the gist of an AVCHD file structure according to the embodiment.

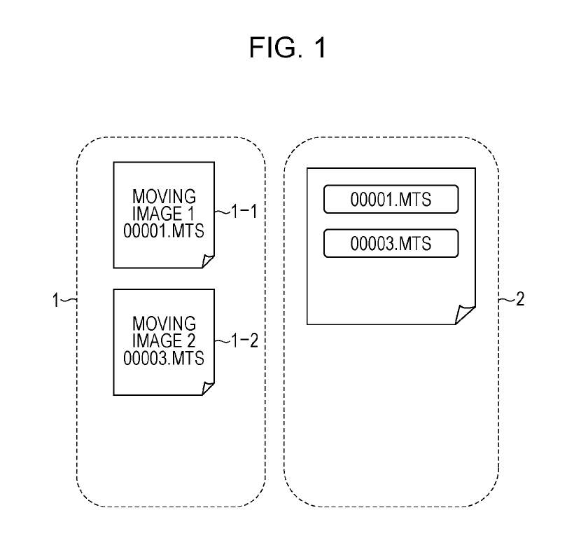

The AVCHD file structure that is illustrated in FIG. 5 is in essence the same as the structure that is illustrated in FIG. 1.

That is, as illustrated in FIG. 5, the AVCHD format includes a moving image file main body 21 and a database file 22 that manages the moving image file main body 21, and a file name and a folder on which a file is to be saved is determined in advance.

The moving image file main body 21 is called as a clip AV stream.

In the example of FIG. 5, a first moving image file 21-1 with the file name “00001.MTS” and a second moving image file 21-2 with the file name “00003.MTS” are present in the moving image file main body 21. Here, MTS is a file extension.

Information such as the file names or the screen sizes of moving image files is stored in the database file 22. The database file 22 is in actuality divided into a plurality of files.

In such a manner, a file in the AVCHD format is formed by a moving image file and a database file, and the folder structure, the file name, and the association between the files are regulated.

A stream file (stream AV file) is accommodated in the moving image file main body 21, and associated information relating to files that are accommodated in the moving image file main body 21 is accommodated in the database file 22.

Furthermore, if the association between the files of the moving image file main body 21 and the database file 22 is regulated and the file of the moving image file main body 21 is deleted, the database file 22 is rewritten, and the associated information file of the deleted file is erased.

Even in a case when a moving image file in the AVCHD format is accidentally deleted with a camera, it is possible to restore the moving image file by a method of the related art.

However, since the contents of the database file are not restored with a method of the related art, there is the inconvenience of not being able to view the moving image.

Therefore, in the embodiment, the CPU 11 includes a function of arranging, once individual files are restored, a file that matches a file group format by the structure of the file group format, and, if necessary, of generating a file that describes the relationship between files or the like.

The CPU 11 becomes able to reproduce and additionally create by an electronic apparatus in which a file is restored in a file group format and the file in the file group format is created and reproduced.

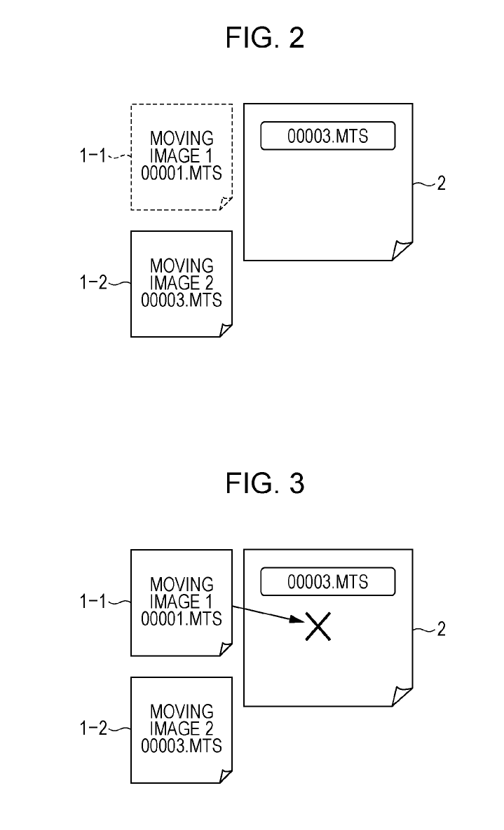

It is supposed that in a camera as an electronic apparatus, a certain moving image file, for example, as illustrated in FIG. 2, the moving image file of the first moving image file 1-1, is mistakenly deleted.

When deleting, the content of the database file 2 is also rewritten, and the data (00001.MTS) of the deleted moving image file is erased.

In such a case, in the embodiment, as illustrated in FIG. 6, since the restored (0001.MTS) information is present on the generated database file side, reproduction becomes possible.

Here, the basic restoration function of the CPU 11 that is the control unit according to the embodiment will be described. Here, the format is collectively referred to as the file group format.

The CPU 11 as a control unit restores, in a case when a file that is stored in the external storage device 14 is deleted, the deleted file. Further, by arranging a file that matches the file group format in a structure of the file group format based on the restored file, the CPU 11 restores the restored file to a file structure corresponding to the file group format.

Further, the CPU 11 arranges a file that matches the file group format in a structure of the file group format based on the restored file as necessary, and generates a file that describes the relationship between files as necessary.

More specifically, after restoring the file of the moving image file main body 21, the CPU 11 restores the associated information of the database file 22 which relates to the restored file based on information of the restored file main body 21.

The CPU 11 extracts a stream file of the file group format from among the restored stream files, and extracts information that is used for restoring the database file 22 from the extracted stream file.

Further, the CPU 11 performs grouping of stream files that are able to exist in one external storage device 14 which are regulated by the file group format.

The CPU 11 extracts a target group that is a database generation target according to the number of grouped stream files, and a list of stream files to be registered in the database is generated based on the target group.

The CPU 11 creates a database that relates to the stream files that are included in the generated list, and saves the stream files and the database in a folder that is regulated in the file group format.

Furthermore, in a case when the number of stream files of the target group (for example, 4000) exceeds the number that is regulated in the file group format, another group is selected as the target group based on information that is used for the restoration of the extracted database file.

### <3. AVCHD Format (AVCHD File Structure)>

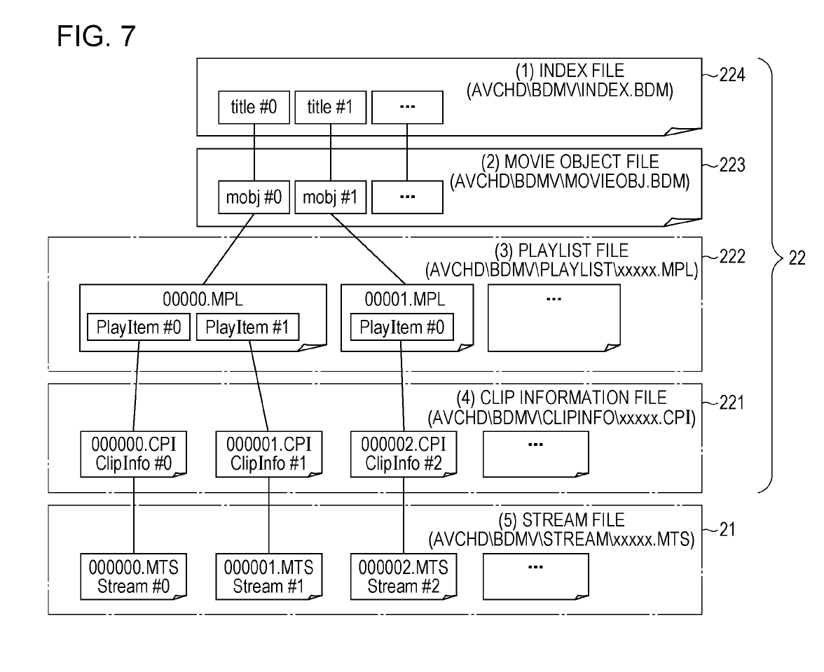

FIG. 7 is a diagram that illustrates the specific relationship between files of the AVCHD format.

Here, the specific relationship between files in the AVCHD format will be described.

In FIG. 7, a stream file (AVCHD¥BDMV¥STREAM¥xxxxx.MTS) that is recorded using MPEG2-TS, for example, is accommodated in the moving image file main body 21.

In FIG. 7, three stream files “000000.MTS Stream #0”, “000001.MTS Stream #1”, and “000002.MTS Stream #2” are exemplified.

The database file 22 is formed by a Clip information file 221, a playlist file 222, a movie object file 223, and an index file 224.

The Clip information file (AVCHD¥BDMV¥CLIPINFO¥xxxxx.CPI) 221 exists one for one with a stream file, and retains information that is used for reproducing stream information.

In FIG. 7, three pieces of Clip information “000000.CPI ClipInfo #0”, “000001.CPI ClipInfo #1”, and “000002.CPI ClipInfo #2” that correspond to the three stream files “000000.MTS Stream #0”, “000001.MTS Stream #1”, and “000002.MTS Stream #2” are exemplified.

The playlist file (AVCHD¥BDMV¥PLAYLIST¥xxxxx.MPL) 222 retains a play item that includes information relating to the reproduction range of a Clip.

In FIG. 7, the play item information “PlayItem #0” that corresponds to the Clip information “000000.CPI ClipInfo #0” and the play item information “PlayItem #1” that corresponds to the Clip information “000001.CPI ClipInfo #1” are exemplified as item information in the file (00000.MPL).

Further, the play item information “PlayItem #0” that corresponds to the Clip information “000002.CPI ClipInfo #2” is exemplified in the file (00001.MPL).

The movie object file (AVCHD¥BDMV¥MOVIEOBJ.BDM) 223 retains a reproduction method or the like of a playlist.

In FIG. 7, the movie object file “mobj #0” that corresponds to the file (00000.MPL) and the movie object file “mobj #1” that corresponds to the file (00001.MPL) are exemplified.

The index file (AVCHD¥BDMV¥INDEX.BDM) 224 retains the reproduction order of a playlist.

In FIG. 7, the index file “title #0” that corresponds to the movie object file “mobj #0” and the index file “title #1” that corresponds to the movie object file “mobj #1” are exemplified.

The CPU 11 as the control unit according to the embodiment restores a Clip AV stream file that is an extension in the restoration process.

After restoring a file, the CPU 11 generates and arranges the Clip information file 221, the playlist file 222, the movie object file 223, and the index file 224 based on information of the Clip AV stream file inside a predetermined folder structure.

In so doing, reproduction and additional image shooting become possible by an electronic apparatus such as a camera.

### <4. Specific Example of Restoration Process by AVCHD Format>

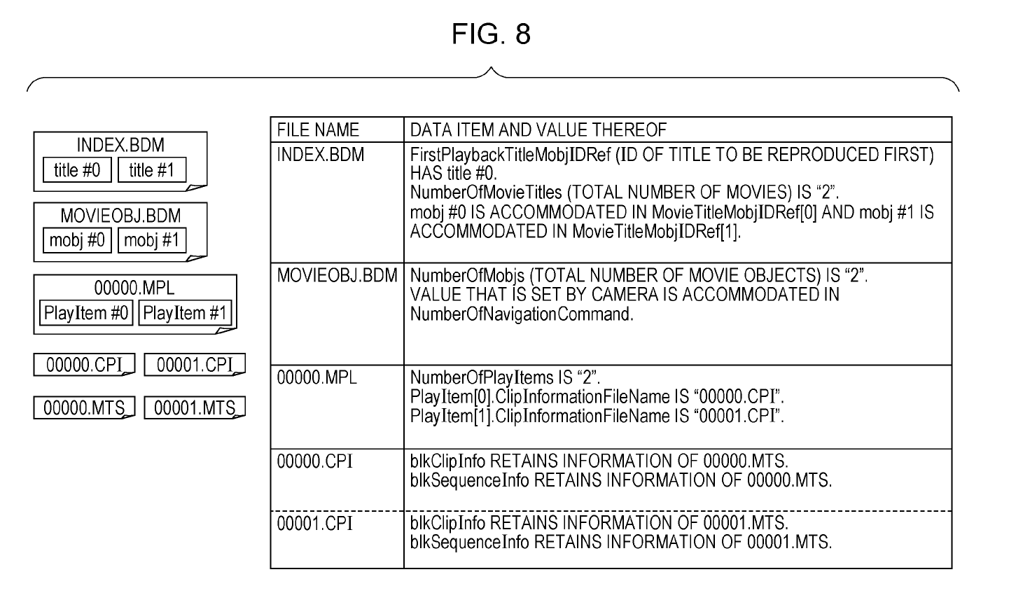

Next, a specific restoration process of a file that is deleted by the CPU 11 as a control unit in a case when the file group format is the AVCHD format as illustrated in FIG. 7 will be described with reference to FIGS. 8 to 10.

Deletion and restoration of a play item will be described in the description below.

The manner in which the related file changes when Clip information is deleted by an electronic apparatus such as a camera will be described.

Here, in order to simplify the description, a case in which there are two play items will be described.

Further, the data items are excerpts.

FIG. 8 is a diagram that illustrates a file structure of the AVCHD format before file deletion.

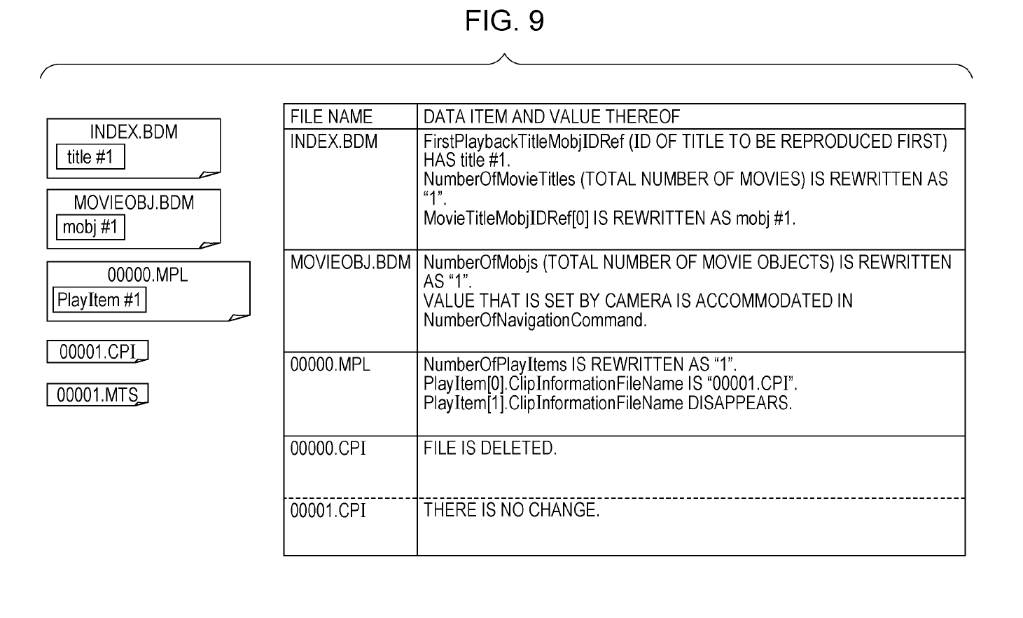

FIG. 9 is a diagram that illustrates a file structure of the AVCHD format when the file (play item #0) is deleted.

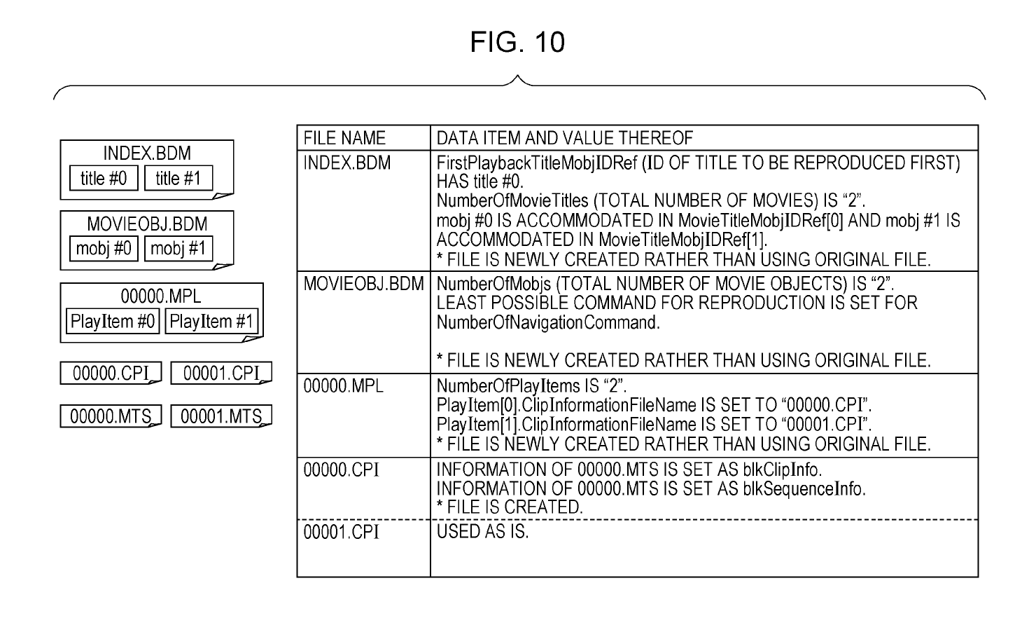

FIG. 10 is a diagram that illustrates a file structure of the AVCHD format when a management file is generated after restoring a stream file.

### [(1) Before Deletion]

The state of FIG. 8 is before file deletion.

The index file (INDEX.BDM) rewrites FirstPlaybackTitleMobjIDRef (ID of the title to be reproduced first) so as to insert title #0 as the data item and the value thereof.

NumberOfMovieTitles (total number of movies) is “2”.

mobj #0 is accommodated in MovieTitleMobjIDRef[0] and mobj #1 is accommodated in MovieTitleMobjIDRef[1].

The movie object file (MOVIEOBJ.BDM) has NumberOfMobjs (total number of movie objects) and “2” as the data item and the value thereof.

A value that is set by a camera is accommodated in NumberOfNavigationCommand.

The play item file (00000.MPL) has NumberOfPlayItems and “2” as the data item and the value thereof.

PlayItem[0].ClipInformationFileName is “00000.CPI”.

PlayItem[1].ClipInformationFileName is “00001.CPI”.

The Clip information file (00000.CPI) has blkClipInfo retaining information of 00000.MTS as the data item and the value thereof.

blkSequenceInfo retains information of 00000.MTS.

The Clip information file (00001.CPI) has blkClipInfo retaining information of 00001.MTS as the data item and the value thereof.

blkSequenceInfo retains information of 00001.MTS.

[(2) Delete PlayItem #0 with Camera]

The state of FIG. 9 is a case when the play item information (PlayItem #0) is deleted with an electronic apparatus such as a camera.

The index file (INDEX.BDM) rewrites FirstPlaybackTitleMobjIDRef (ID of the title to be reproduced first) so as to insert title #1 as the data item and the value thereof.

NumberOfMovieTitles (total number of movies) is rewritten as “1”.

MovieTitleMobjIDRef[0] is rewritten as mobj #1.

The movie object file (MOVIEOBJ.BDM) rewrites NumberOfMobjs (total number of movie objects) and “1” as the data item and the value thereof.

A value that is set by a camera is accommodated in NumberOfNavigationCommand.

The play item file (00000.MPL) rewrites NumberOfPlayItems and “1” as the data item and the value thereof.

PlayItem[0].ClipInformationFileName is “00001.CPI”.

PlayItem[1].ClipInformationFileName disappears.

The file is deleted for the Clip information file (00000.CPI).

There is no change for the Clip information file (000001.CPI).

### [(3) When Generating Management File After Restoring Stream File]

The state of FIG. 10 is when generating a management file after restoring a stream file.

The index file (INDEX.BDM) rewrites FirstPlaybackTitleMobjIDRef (ID of the title to be reproduced first) so as to insert title #0 as the data item and the value thereof.

NumberOfMovieTitles (total number of movies) is “2”.

mobj #0 is accommodated in MovieTitleMobjIDRef[0] and mobj #1 is accommodated in MovieTitleMobjIDRef[1].

At such a time, a new file is created rather than using the original file.

The movie object file (MOVIEOBJ.BDM) accommodates “2” in NumberOfMobjs (total number of movie objects) as the data item and the value thereof.

The least possible command for reproduction is set for NumberOfNavigationCommand.

At such a time, a new file is created rather than using the original file.

The play item file (00000.MPL) sets NumberOfPlayItems as “2” as the data item and the value thereof.

PlayItem[0].ClipInformationFileName is set as “00000.CPI”.

PlayItem[1].ClipInformationFileName is set as “00001.CPI”.

At such a time, a new file is created rather than using the original file.

The Clip information file (00000.CPI) has blkClipInfo setting information of 00000.MTS as the data item and the value thereof.

blkSequenceInfo sets information of 00000.MTS.

The file is created.

The Clip information file (00001.CPI) is used as is as the data item and the value thereof.

In such a manner, after restoring the file, the CPU 11 generates and arranges the Clip information file 221, the playlist file 222, the movie object file 223, and the index file 224 based on information of the Clip AV stream file inside a predetermined folder structure.

In so doing, reproduction and additional image shooting become possible by an electronic apparatus such as a camera.

### <5. Overall Flow of Restoration Procedure>

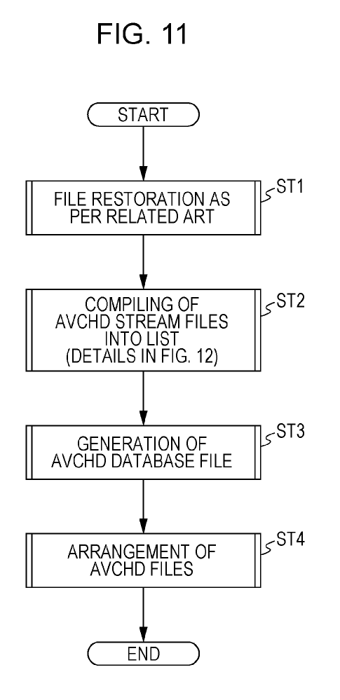

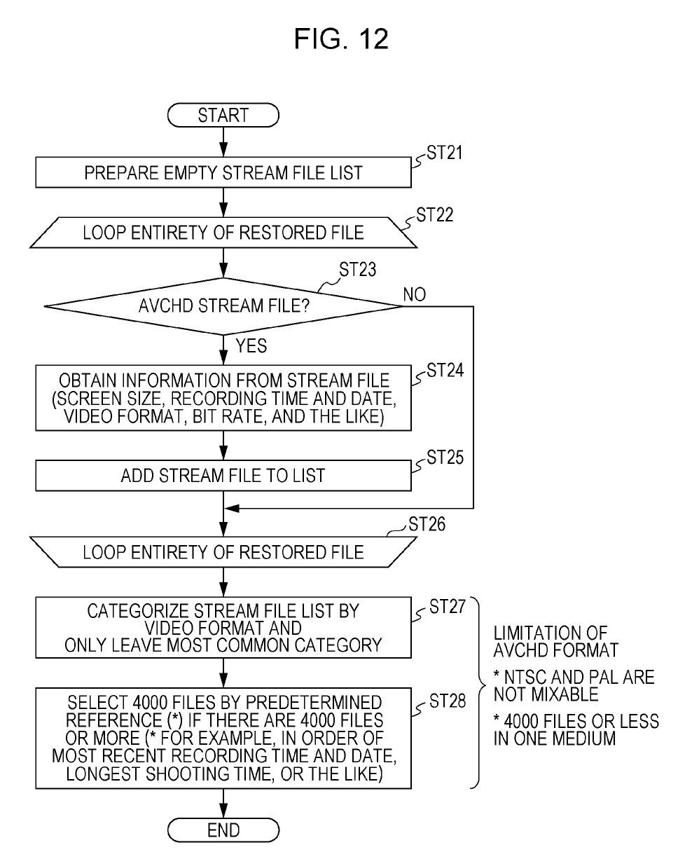

Next, the overall procedure of the file restoration process by an information processing device according to the disclosure will be described with reference to the flowcharts of FIGS. 11 and 12.

FIG. 11 is a flowchart for describing the overall procedure of a file restoration process in an information processing device according to the embodiment.

FIG. 12 is a flowchart for describing a process of compiling AVCHD stream files into a list.

Here, as the AVCHD format, there is a limitation that NTSC and PAL are not mixable, and that there are 4000 or fewer files in one medium.

First, a stream file is restored by a predetermined method of file restoration (ST1). At such a time, other than the stream file, still images (*.jpg) and text (*.txt), for example, are also restored.

The file restoration by a predetermined method is performed, for example, including the processing steps below.

The file restoration includes a step of detecting that at least a portion of the main data of a file has been destroyed, and a step of detecting that a file region that accommodates sub data is remaining as normal. Further, a step of copying the sub data of a file region onto the main data and turning the sub data into a file once it is detected that the file region is remaining as normal is included.

Next, an AVCHD stream file is extracted from among the restored files.

At such a time, there may be a function of displaying an image near the front of the stream file and the user selecting the stream file to be restored. With such a function of choosing a file, a default value of a state in which all files are selected is a desirable process to avoid unnecessary trouble for the user.

Next, a list of stream files to be registered in the database is created according to the process of FIG. 12, for example (step ST2 of FIG. 11, steps ST21 to ST28 of FIG. 12).

In order to create a list, first, information that is used for database restoration is extracted from the extracted AVCHD stream files.

Next, grouping of stream files that are able to exist on one medium which is regulated in the AVCHD format is performed.

For example, stream files with different video formats (NTSC or PAL) are not able to exist on one medium at the same time.

Next, the numbers of stream files that are grouped are compared. The group with the most files becomes the primary target group that is a database generation target.

Next, if the number of stream files in the primary target group exceeds 4000, 4000 files from the most recent shooting time and date become a secondary target group.

In a case when the number of files does not exceed 4000, the primary target group becomes the secondary target group as is. At such a time, instead of using the shooting time and date as the reference, various information relating to the stream files such as the shooting time or the screen size of the image may be used as the reference.

Next, by lining up the stream files of the secondary target group in order from the oldest shooting time and date, the list of stream files to be registered in the database is completed.

The contents of each of the steps ST21 to ST28 in the flow of FIG. 12 are as below.

In step ST21, an empty stream file list is prepared.

In step ST22, a loop process of the entirety of the restored file is performed.

In step ST23, determination of whether or not the file is an AVCHD stream file is performed.

In step ST24, in a case when the file is an AVCHD stream file, information is obtained from the stream file. Screen size, recording time and date, video format, bit rate, and the like are exemplified as information to be obtained.

In step ST25, the stream file is added to the list.

In step ST26, a loop process of the entirety of the restored file is performed.

In step ST27, the stream file list is categorized by video format, and only the most common category is left. In such a case, if there are 4000 files or more, 4000 files are selected by a predetermined reference (*). For example, the reference (*) is the order of the most recent recording time and date, the longest shooting time, or the like.

Next, a database relating to the stream files that are included in the list is created (ST3).

Next, the stream files and the database are saved in a folder that is regulated in the AVCHD format (ST4). Saving to a folder may be performed at the same time as the creation of the database.

According to the embodiment, in a case when a moving image is deleted by a camera from a medium that is shot in a file group format such as the AVCHD format, by using an information processing device according to the embodiment, as illustrated in FIG. 6, it becomes possible to reproduce the deleted moving image with the camera.

In the related art, it was difficult to reproduce with a camera unless the database was restored using separate moving image management software after restoring the stream file with file restoration software.

On the other hand, if an information processing device according to the embodiment is built into a file restoration system, reproduction with an electronic apparatus such as a camera is possible by easily restoring a file group format such as the AVCHD format.

### <6. Configuration Example of Electronic Apparatus>

The information processing device 10 including the above functions is able to be applied to various electronic apparatuses.

That is, the information processing device 10 according to the embodiment is able to be applied to a display device of an electronic apparatus of any field in which a video signal that is input to the electronic apparatus or a video signal that is generated within the electronic apparatus is displayed as an image or a video.

Here, as the electronic apparatus, digital cameras, notebook personal computers, mobile terminal devices (mobile apparatuses) such as mobile phones, desktop personal computers, video cameras, and the like are exemplified.

An example of an electronic apparatus to which the embodiment is applied will be described below.

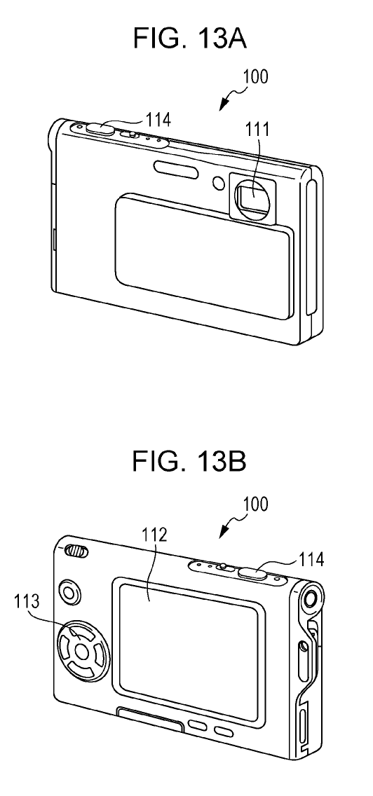

FIGS. 13A and 13B are perspective diagrams that illustrate a digital camera to which an information processing device of the embodiment is able to be applied, where FIG. 13A is a perspective diagram seen from the front side and FIG. 13B is another perspective diagram seen from the back side.

A digital camera 100 according to the applied example includes a light emitting portion 111 for the flash, a display unit 112, a menu switch 113, a shutter button 114, and the like.

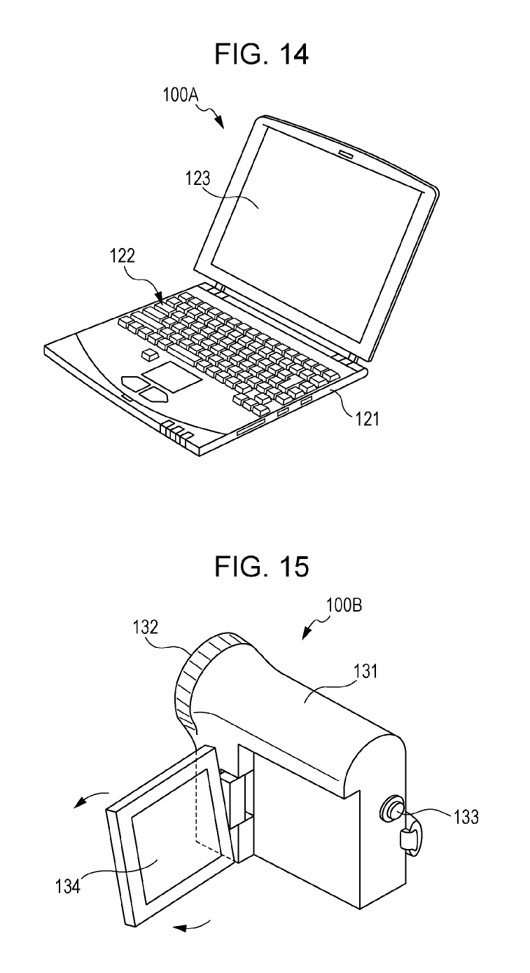

FIG. 14 is a perspective diagram that illustrates a notebook personal computer to which an information processing device of the embodiment is able to be applied.

A notebook personal computer 100A according to the applied example includes a keyboard 122 that is operated when inputting characters or the like, a display unit 123 that displays an image, and the like on a main body 121.

FIG. 15 is a perspective diagram that illustrates a video camera to which an information processing device of the embodiment is able to be applied.

A video camera 100B according to the applied example includes a main body portion 131, a lens 132 for shooting a subject on a forward-facing side surface, a start and stop switch 133 for when shooting, a display unit 134, and the like.

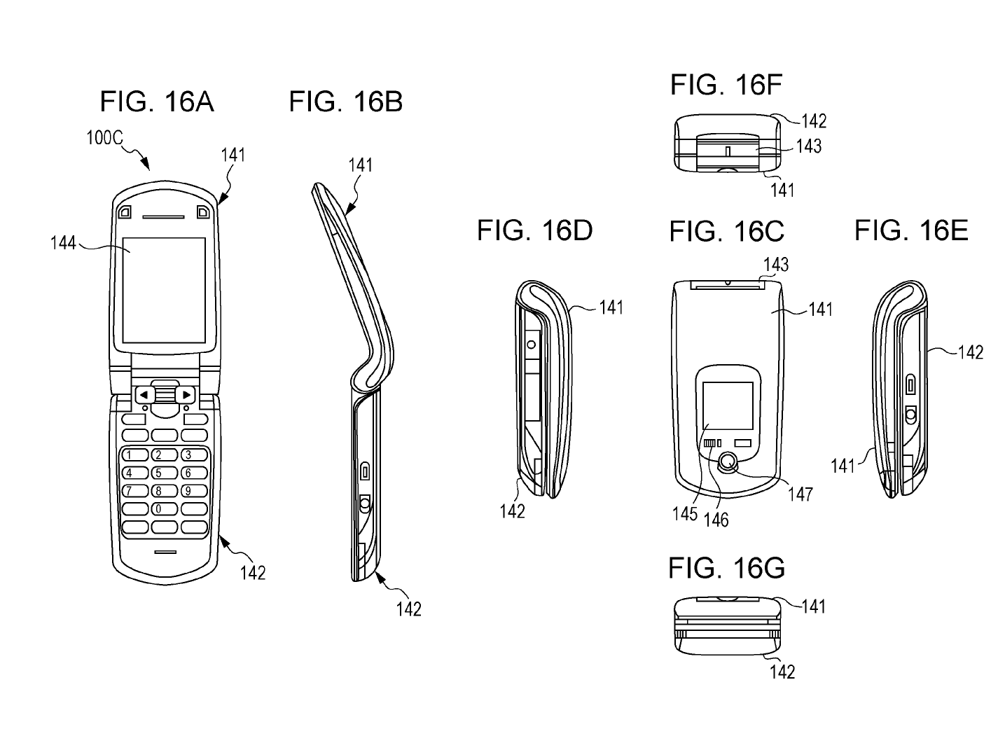

FIGS. 16A to 16G are diagrams that illustrate a mobile terminal device, for example, a mobile phone, to which an information processing device of the embodiment is able to be applied. FIG. 16A is a front view in an opened state, FIG. 16B is a side view thereof, FIG. 16C is a front view in a closed state, FIG. 16D is a left side view, FIG. 16E is a right side view, FIG. 16F is a top view, and FIG. 16G is a bottom view.

A mobile phone 100C according to the applied example includes an upper side housing 141, a lower side housing 142, a connecting portion (here, hinge portion) 143, a display 144, a sub display 145, a picture light 146, a camera 147, and the like.

In addition, the methods described in detail above are able to be formed as a program according to the above procedures and configured to be executed by a computer such as a CPU.

Further, such a program is able to be configured by executing the program by accessing a computer in which a recording medium such as a semiconductor memory, a magnetic disk, an optical disc, or a floppy (registered trademark) disk is set.

The present disclosure contains subject matter related to that disclosed in Japanese Priority Patent Application JP 2010-250625 filed in the Japan Patent Office on Nov. 9, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing device comprising:
a storage device in which a plurality of files are stored in a file group in which a plurality of files are associated with one another and in a file group format in which the association is regulated, and which is able to delete a stored file; and
a control unit that is able to restore a file that is deleted from files that are stored in the storage device,
wherein in a case when a file that is stored in the storage device is deleted, the control unit restores a deleted file and restores the restored file to a file structure according to a file group format by arranging a file that matches a file group format in a structure of a file group format based on a restored file.

2. The information processing device according to claim 1,
wherein the control unit arranges a file that matches a file group format in a structure of a file group format based on a restored file, and generates a file that describes a relationship between files as necessary.

3. The information processing device according to claim 1,
wherein the file group format includes:
a file main body in which a stream file is accommodated; and
a database file in which associated information relating to a file that is accommodated in the file main body is accommodated,
wherein association between files of the file main body and the database file is regulated,
wherein when a file of the file main body is deleted, the database file is rewritten, and associated information of the deleted file is erased, and
wherein the control unit restores, after restoring a file of the file main body, associated information of the database file that relates to a restored file based on information of the restored file main body.

4. The information processing device according to claim 3,
wherein the control unit extracts a stream file of the file group format from a restored stream file and extracts information that is used for restoration of the database file from an extracted stream file.

5. The information processing device according to claim 4,
wherein the control unit performs grouping of stream files that are regulated by the file group format which are able to exist in one storage device, extracts a target group that is a database generation target according to a number of grouped stream files, generates a list of stream files to be registered in a database based on the target group, creates a database that relates to stream files that are included in the list, and saves stream files and a database in a folder that is regulated by the file group format.

6. The information processing device according to claim 5,
wherein the control unit selects, in a case when a number of stream files of the target group exceeds a number that is regulated by the file group format, a different group as a target group based on information that is used for restoration of the extracted database.

7. The information processing device according to claim 3,
wherein the database file includes
a Clip information file that exists one for one with a stream file and which retains information that is used for reproducing stream information,
a playlist file that retains a play item that includes at least information relating to a reproduction range of a Clip,
a movie object file that retains at least a reproduction method of a playlist, and
an index file that retains a reproduction order of a playlist,
wherein the control unit generates and arranges, after restoring a Clip AV stream file of an extension, a Clip information file, a playlist file, the movie object file, and an index file based on information of the Clip AV stream file, in a predetermined folder structure.

8. An electronic apparatus comprising:
an information processing device that restores a file that is deleted from files in which a plurality of files are stored in a predetermined format,
wherein the information processing device includes
a storage device in which a plurality of files are stored in a file group in which a plurality of files are associated with one another and in a file group format in which the association is regulated, and which is able to delete a stored file, and
a control unit that is able to restore a file that is deleted from files that are stored in the storage device,
wherein in a case when a file that is stored in the storage device is deleted, the control unit restores a deleted file and restores the restored file to a file structure according to a file group format by arranging a file that matches a file group format in a structure of a file group format based on a restored file.

9. An information processing method comprising:
storing a plurality of files in a file group in which a plurality of files are associated with one another and in a file group format in which the association information is regulated; and
restoring a file that is deleted from files that are stored in the storage device,
wherein in the restoring, in a case when a file that is stored in the storage device is deleted, a deleted file is restored, and by arranging a file that matches a file group format in a structure of a file group format based on a restored file, the restored file is restored to a file structure according to a file group format.

10. The information processing method according to claim 9,
wherein in the restoring, a file that matches a file group format is arranged in a structure of a file group format based on a restored file, and a file that describes a relationship between files is generated as necessary.

11. The information processing method according to claim 9,
wherein the file group format includes
a file main body in which a stream file is accommodated and
a database file in which associated information relating to a file that is accommodated in the file main body is accommodated,
wherein association between files of the file main body and the database file is regulated,
wherein when a file of the file main body is deleted, the database file is rewritten, and associated information of the deleted file is erased, and
wherein in the restoring, after a file of the file main body is restored, associated information of the database file that relates to a restored file is restored based on information of the restored file main body.

12. The information processing method according to claim 11,
wherein in the restoring, a stream file of the file group format is extracted from a restored stream file and information that is used for restoration of the database file is extracted from an extracted stream file.

13. The information processing method according to claim 12,
wherein in the restoring, grouping of stream files that are regulated by the file group format which are able to exist in one storage device is performed, a target group that is a database generation target is extracted according to a number of grouped stream files, a list of stream files to be registered in a database is generated based on the target group, a database that relates to stream files that are included in the list are created, and stream files and a database are saved in a folder that is regulated by the file group format.

14. The information processing method according to claim 13,
wherein in the restoring, in a case when a number of stream files of the target group exceeds a number that is regulated by the file group format, a different group is selected as a target group based on information that is used for restoration of the extracted database.

15. The information processing method according to claim 11,
wherein the database file includes
a Clip information file that exists one for one with a stream file and which retains information that is used for reproducing stream information,
a playlist file that retains a play item that includes at least information relating to a reproduction range of a Clip,
a movie object file that retains at least a reproduction method of a playlist, and
an index file that retains a reproduction order of a playlist,
wherein in the restoring, the control unit generates and arranges, after restoring a Clip AV stream file of an extension, a Clip information file, a playlist file, the movie object file, and an index file based on information of the Clip AV stream file, in a predetermined folder structure.

16. A program that causes a computer to execute information processing of:
storing a plurality of files in a storage device in a file group in which a plurality of files are associated with one another and in a file group format in which the association information is regulated; and
restoring a file that is deleted from files that are stored in the storage device,
wherein in the restoration process, in a case when a file that is stored in the storage device is deleted, a deleted file is restored, and by arranging a file that matches a file group format in a structure of a file group format based on a restored file, the restored file is restored to a file structure according to a file group format.
